(19) United States
(12) Patent Application Publication
(10) Pub. No.: US 2006/0178171 A1
(43) Pub. Date: Aug. 10, 2006

(54) Audio/charging module and electronic system and porable electronic device thereof

(75) Inventor: Wan-Hsieh Liu, Taipei County (TW)

Correspondence Address: BIRCH STEWART KOLASCH & BIRCH, PO BOX 747, FALLS CHURCH, VA, 22040-0747, US

(73) Assignee: HIGH TECH COMPUTER, CORP.

(21) Appl. No.: 11/345,254

(22) Filed: Feb. 2, 2006

(30) Foreign Application Priority Data
Feb. 5, 2005 (TW) 94103966

(51) Int. Cl. H04B 1/38; H04M 1/00

(52) U.S. Cl. 455/573

(57) ABSTRACT

The invention utilizes an audio signal line of an earphone jack in an electronic system to charge a portable electronic device. By using an audio/charging module in the electronic system and another audio/charging module in the portable electronic device, a charging mode is established in which a first audio signal line of earphone jack carries a power signal to charge the portable electronic device.

### BACKGROUND

The invention is related to an audio/charging module and, more particularly, to an audio/charging module in an electronic system which is capable of charging a portable electronic device via an audio signal line of an earphone jack.

An earphone jack is a standard connector receiving an earphone plug of audio receiving devices. A typical earphone jack has three signal lines, a first and second audio signal line and a ground voltage line. The first and second audio signal lines carry left and right audio channels.

An electronic system, such as a computer or digital music storage/processing system, can output audio via the two audio signal lines to an external device, such as an MP3 player or a Personal Digital Assistant (PDA). The two audio signal lines are connected to two audio output pins of an audio codec chip of the electronic system. The audio codec chip is used for converting digital audio signals to analog audio signals. The electronic system can also receive audio via the two audio signal lines from an external device. The two audio signal lines are then connected to two audio input pins of the audio codec chip of the electronic system. The audio codec chip here is used for converting analog audio signals to digital audio signals.

A portable electronic device with music storage/processing function typically has two earphone connectors for input and output of audio. Additionally a power connector is disposed on the portable electronic device for connecting to a power supply or charging the battery of the portable electronic device.

FIG. 1 is a block diagram of a conventional electronic system or portable electronic device 10 with music storage/processing function. The system comprises a power connector 14, an earphone connector 11, a microphone connector 15, an audio codec chip 12 and a charging power 13. The charging power 13 connects to the rechargeable battery when 10 is a portable electronic device, and connects to an internal power supply when 10 is an electronic system capable of charging an external device.

The power connector 14 connects to the charging power 13. The earphone connector and the microphone connector connect to the audio codec chip. Three connectors are required for audio input/output and charging functions.

Reducing device size is a demand in portable electronic device design. Connectors for external devices are required and occupy external space of the portable electronic device. Reducing the space required for the connectors is a major target in design of portable electronic devices.

### SUMMARY

The invention provides an audio/charging module in an electronic system with an earphone jack, comprising: a control unit generating a charging control signal having a first and second state; a switching unit coupled between the earphone jack and an audio codec chip and receiving the charging control signal; wherein the switching unit electrically couples a first audio signal line of the earphone jack to a charging power when the charging control signal is in the first state, and to the codec chip when the charging control signal is in the second state.

The invention further provides an audio/charging module in a portable electronic device with connection of an earphone plug, comprising: a control unit generating a charging control signal having a first state and second state; a switching unit coupled between the earphone plug and a audio codec chip and receiving the charging control signal; wherein the switching unit electrically couples a first audio signal line of the earphone plug to a charging module when the charging control signal is in the first state, and to the codec chip when the charging control signal is in the second state.

The invention further provides an electronic system comprising an earphone jack, an audio codec and connected between them, an audio/charging module coupled to a charging power of the electronic system with a charging mode, wherein the audio/charging module electrically couples a first audio signal line of the earphone jack to the charging power when the electronic system is in the charging mode, and to the audio codec chip when the electronic system is not in charging mode.

The invention further provides another portable electronic device comprising an earphone plug interface, an audio codec and connected between them, an audio/charging module coupled to a charging power of the electronic system with a charging mode, wherein the audio/charging module electrically couples a first audio signal line of the earphone plug interface to a charging power supply when the portable electronic device is in the charging mode, and to the audio codec chip when the portable electronic device is not in the charging mode.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute a part of this specification, illustrate embodiments of the invention and, together with the description, serve to explain the features, advantages, and principles of the invention.

FIG. 1 is a block diagram of a conventional electronic system or portable electronic device 10 with audio output/input function.

FIGS. 2A, 3A, 4A and 5A are block diagrams of electronic systems or portable electronic devices according to embodiments of the invention.

FIGS. 2B, 3B, 4B and 5B are embodiments of the audio/charging modules shown in FIGS. 2A, 3A, 4A and 5A respectively.

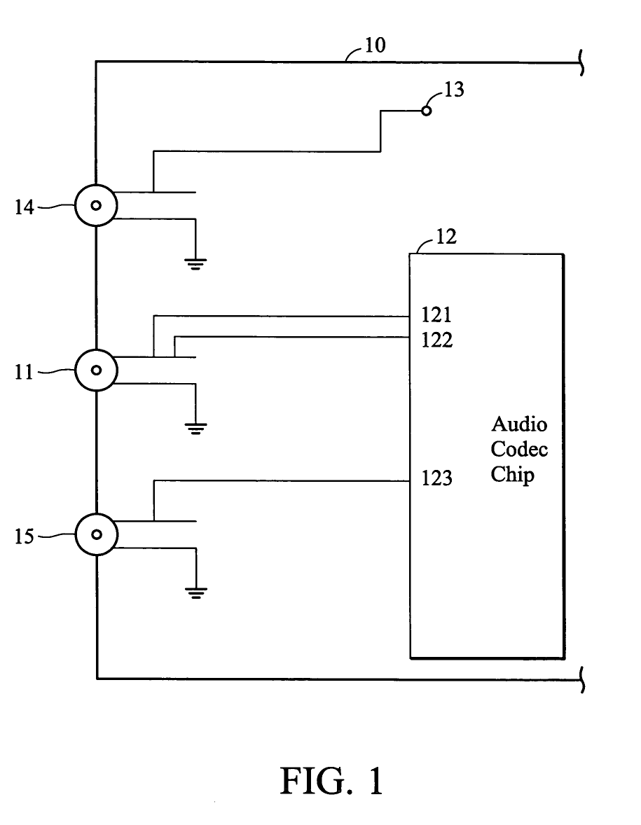

### DETAILED DESCRIPTION

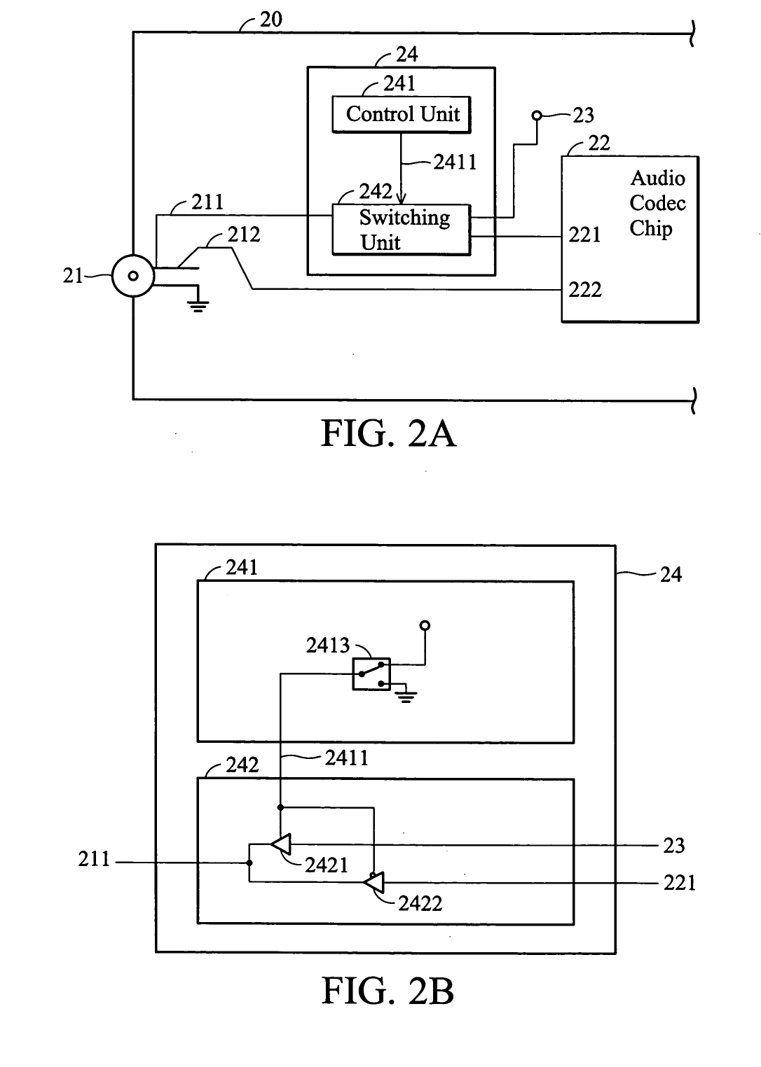

FIG. 2A is a block diagram of an electronic system 20 according to an embodiment of the invention. The electronic system 20 comprises an earphone jack 21, an audio codec chip 22, a charging power 23 and an audio/charging module 24.

In this embodiment, a first audio signal line 211 of the earphone jack 21 couples to a switching unit 242 of the audio/charging module 24. The switching unit 242 receives a charging control signal 2411 from a control unit 241 of an audio/charging module 24, and couples to an audio output pin 221 of the audio codec chip 22 and to the charging power 23. A second audio signal line 212 of the earphone jack 21 couples to an audio output pin 222 of the audio codec chip 22.

FIG. 2B is an embodiment of the audio/charging module 24 shown in FIG. 2A. A switching device 2413 controls the voltage level of the charging control signal 2411. The switching device 2413 can be implemented by using an electronic switch which can be controlled manually. The switching device 2413 can also be a part of a controller in the electronic system 20, programmable by registers (not shown) thereof to determine the voltage level of the signal.

As shown in this embodiment, when charging control signal 2411 is in a high state, buffer 2421 is ON and buffer 2422 is OFF, the first audio signal line 211 is coupled to charging power 23 and provides the charging power. When charging control signal 2411 is in a low state, buffer 2421 is OFF and buffer 2422 is ON, the first audio signal line 211 is coupled to the output pin 221 of the audio codec 22 and delivers audio signal.

In this embodiment, the high level of the charging control signal 2411 of the audio/charging module 24 indicates that the electronic system 20 is in a charging mode. When the system 20 operates in the charging mode, the audio/charging module 24 electrically couples the first audio signal line 211 to the charging power 23. When the system 20 is not in the charging mode, the first audio signal line 211 of the audio/charging module 24 is electrically coupled to the audio codec chip 22.

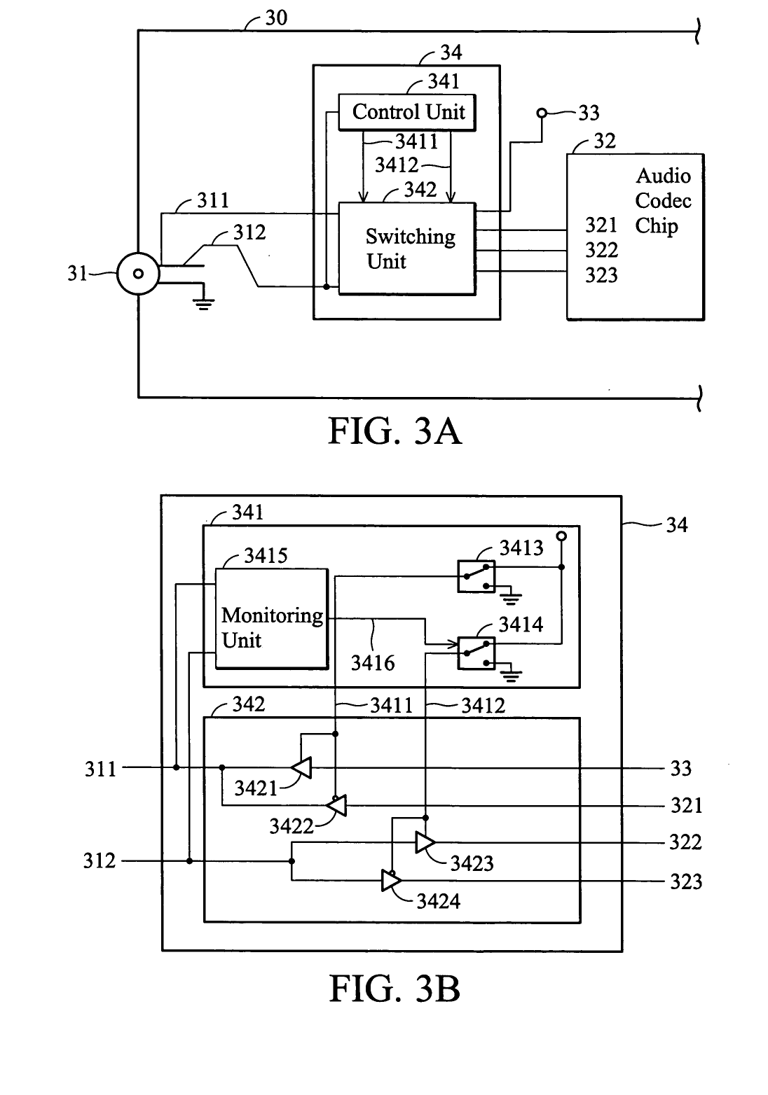

FIG. 3A is a block diagram of an electronic system 30 according to another embodiment of the invention. The electronic system 30 comprises an earphone jack 31, an audio codec chip 32, a charging power 33 and an audio/charging module 34.

In this embodiment, a first and a second audio signal lines 311 and 312 of the earphone jack 31 are coupled to a switching unit 342 of the audio/charging module 34. The switching unit 342 receives a charging control signal 3411 and a switching control signal 3412 from a control unit 341 of the audio/charging module 34, and further couples to audio output pins 321 and 322 of the audio codec chip 32, an audio input pin 323 and the charging power 33.

FIG. 3B is an embodiment of the audio/charging module 34 shown in FIG. 3A. Switching devices 3413 and 3414 control the voltage level of the charging control signal 3411 and the switching control signal 3412 respectively. The switching device 3413 and 3414 may be implemented by using an electronic switch which can be controlled manually. The switching device 3413 and 3414 can also be a part of a controller in the electronic system 30, programmable by registers (not shown) thereof to determine the voltage level of the charging control signal 3411 and the switching control signal 3412. In this embodiment, when charging control signal 3411 is in a high state, buffer 3421 is ON and buffer 3422 is OFF, first audio signal line 311 is connected to charging power 33 and provides the charging power. When charging control signal 3411 is in a low state, buffer 3421 is OFF and buffer 3422 is ON, first audio signal line 311 is connected to the output line 321 of the audio codec 32 and delivers audio.

When switching control signal 3412 is in a high state, buffer 3423 is ON and buffer 3424 is OFF, the second audio signal line 312 is connected to the audio output pin 322 of the audio codec chip 32 and outputs audio. When switching control signal 3412 is in a low state, buffer 3423 is OFF and buffer 3424 is ON, the second audio signal line 312 is connected to input pin 323 of the audio codec chip 32 and receives audio.

This embodiment further provides a monitoring unit 3415 coupled to the second audio signal line 312 and the switching device 3414 for an additional function. Monitoring unit 3415 is a waveform comparator comprising a waveform data storage device (memory), a counter, and a comparator. When the switching control signal 3412 is at a high level, i.e. the second audio signal line 312 is connected to the audio output pin 322 of the audio codec chip 32, monitoring unit 3415 compares a waveform on the second audio signal line 312 with a predetermined waveform in the memory. If the second audio signal line 312 matches the predetermined waveform, the monitoring unit 3415 directs the switching device 3414 to change state to high using signal 3416, and makes the second audio signal line 312 connect to the audio output pin 322 of the audio codec chip 32.

In this embodiment, the high level period of the charging control signal 3411 is regarded as a charging mode of the electronic system 30. When the system 30 is in the charging mode, the audio/charging module 34 electrically couples the first audio signal line 311 of the earphone jack 31 to the charging power 33. When the system 30 is not in the charging mode, the audio/charging module 34 electrically couples the first audio signal line 311 to the audio output pins 321 of the audio codec chip 32.

In this embodiment, the low level period of the switching control signal 3412 is also considered an input mode of the electronic system 30, wherein system 30 inputs audio from earphone jack 31. When the system 30 is in the input mode, the audio/charging module 34 electrically couples the second audio signal line 312 of the earphone jack 31 to the input pin 323 of the audio codec 32. When the system 30 is not in the input mode, the audio/charging module 34 electrically couples the second audio signal line 312 to the output pin 322 of the audio codec 32.

This embodiment is further capable of switching the electronic system 30 to leave the input mode when the electronic system 30 is in the input mode and the second audio signal line 312 receives a predetermined waveform, wherein system 30 then output music materials using earphone jack 31.

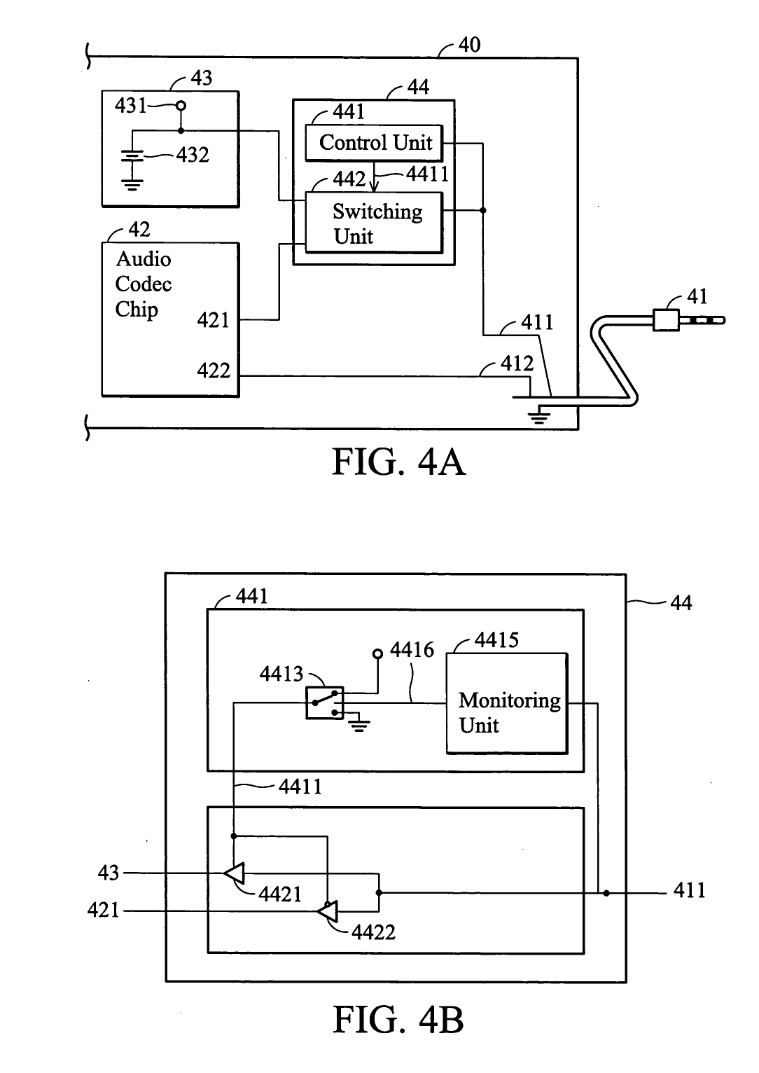

FIG. 4A is a block diagram of a portable electronic device 40 according to an embodiment of the invention. The portable electronic device 40 comprises an earphone plug interface 41, an audio codec chip 42, a charging module 43 and an audio/charging module 44. Charging module 43 comprises a battery 432 and a charging power 431, wherein battery 432 will be charged when charging power 431 is provided from an external device via earphone plug interface 41. The external device may be a device capable of providing power, such as electronic device 30 shown in FIG. 3A in charging mode, or a DC power supply.

In this embodiment, a first audio signal line 411 of the earphone plug interface 41 couples to switching unit 442 of audio/charging module 44. The switching unit 442 receives a charging control signal 4411 from control unit 441 of audio/charging module 44, and couples to audio input pin 421 of the audio codec chip 42 and the charging module 43. Second audio signal line 412 couples to another audio input pin 422 of the audio codec chip 42.

FIG. 4B is an embodiment of the audio/charging module 44 shown in FIG. 4A. Switching device 4413 controls the voltage level of the charging control signal 4411. The switching device 4413 can be implemented using an electronic switch which can be controlled manually. The switching device 4413 can also be a part of a controller in the electronic system 40, programmable by registers (not shown) thereof to determine the voltage level of the signal. As shown in this embodiment, when the charging control signal 4411 is in a high state, a buffer 4421 is ON and a buffer 4422 is OFF, the first audio signal line 411 is connected to the charging module 43 for charging. When the charging control signal 4411 is in a low state, buffer 4421 is OFF and a buffer 4422 is ON, the first audio signal line 411 is connected to the input pin 421 of the audio codec 42 to receive audio materials.

In this embodiment, a monitoring unit 4415 coupled to the first audio signal line 411 and switching device 4413 is further provided for an additional function. The monitoring unit 4415 is a waveform comparator comprising a waveform data storage device (memory), a counter, and a comparator. When charging control signal 4411 is at low level, i.e. the first audio signal line 441 is connected to the audio input pin 421 of the audio codec chip 42, the monitoring unit 4415 monitors if a waveform on the first audio signal line 411 is identical to a predetermined waveform in the waveform comparator. When the waveform on the first audio signal line 411 matches predetermined waveform, the monitoring unit 4415 directs the switching device 4413 to change state to high using signal 4416, and makes the first audio signal line 411 connect to the charging module 43.

In this embodiment, the high level period of the charging control signal 4411 of the audio/charging module 44 indicates a charging mode of the portable electronic device 40. When portable electronic device 40 is in the charging mode, the audio/charging module 44 electrically couples the first audio signal line 411 of the earphone plug interface 41 to the charging module 43. When the system 40 is not in the charging mode, the audio/charging module 44 electrically couples the first audio signal line 411 to the audio codec chip 42. This embodiment is further capable of switching the portable electronic device 40 to charging mode when the portable electronic device 40 is not in the charging mode and the first audio signal line 411 receives a predetermined waveform.

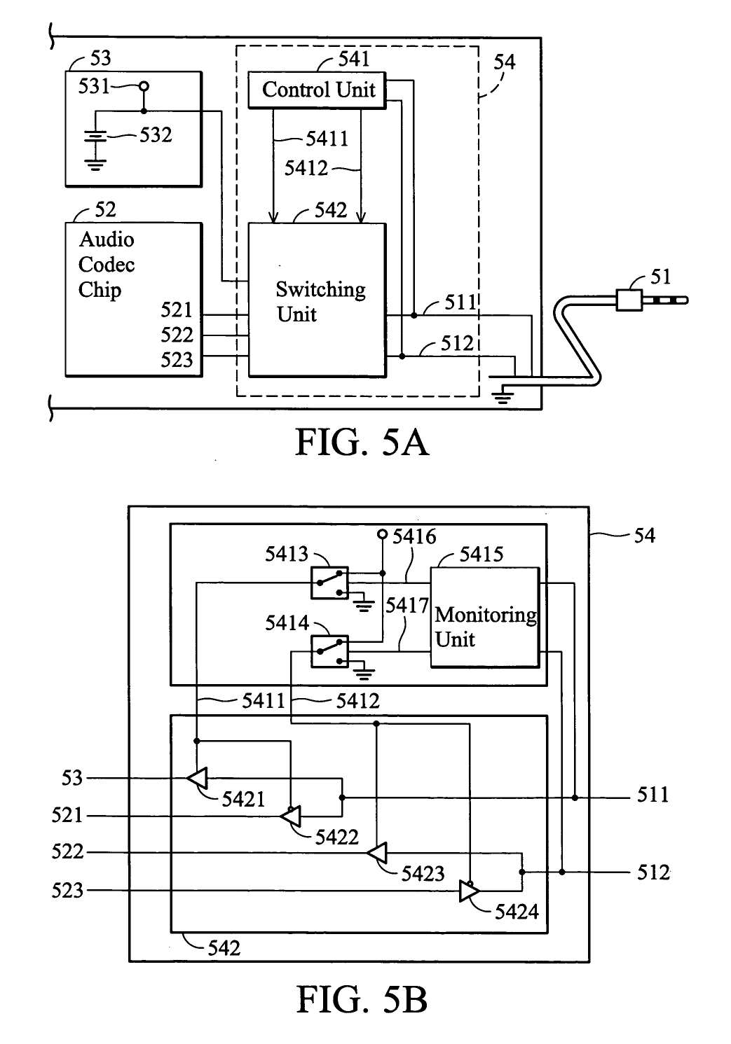

FIG. 5A is a block diagram of a portable electronic device 50 according to another embodiment of the invention. The portable electronic device 50 comprises an earphone plug interface 51, an audio codec chip 52, a charging module 53 and an audio/charging module 54. Charging module 53 comprises a battery 532 and a charging power 531, wherein battery 532 is charged when charging power 531 is provided from an external device via earphone plug interface 51. The external device may be a device capable of providing power, such as electronic device 30 shown in FIG. 3A in charging mode, or a DC power supply.

In this embodiment, a first audio signal line 511 and second audio signal line 512 of the earphone plug interface 51 couples to a switching unit 542 and a control device 541 of the audio/charging module 54. The switching unit 542 receives a charging control signal 5411 and a switching control signal 5412 of control unit 541, and couples to audio input pin 521 and 522, output pin 523 and the charging module 53.

FIG. 5B is an embodiment of the audio/charging module 54 shown in FIG. 5A. Switching device 5413 and 5414 control the voltage level of the charging control signal 5411 and the switching control signal 5412 respectively. The switching device 5413 and 5414 may be implemented using an electronic switch which may be controlled manually by the user. The switching device 5413 and 5414 may also be implemented using a part of a controller of the portable electronic device 50, programmable by registers thereof (not shown) to determine the voltage level of the signal.

Shown in this embodiment, when charging control signal 5411 is in a high state, buffer 5421 is ON and buffer 5422 is OFF, and the first audio signal line 511 is connected to the charging module 53 for charging. When the charging control signal 5411 is at low level, buffer 5421 is OFF and a buffer 5422 is ON, the input pin 521 of the audio codec 52 is connected to the first audio signal line 511 to receive audio.

Also shown in this embodiment, when the switching control signal 5412 is in a high state, a buffer 5423 is ON and a buffer 5424 is OFF, the audio input pin 522 of the audio code chip 52 is connected to the second audio signal line 512 to receive audio materials. When the switching control signal 5412 is in a low state, buffer 5423 is OFF and a buffer 5424 is ON, the output pin 523 of the audio codec 52 is connected to the second audio signal line 511 to output audio.

This embodiment further provides a monitoring unit 5415 coupled to the second audio signal line 512 and switching device 5414 to provide an additional function. The monitoring unit 5415 is a waveform comparator, which can be implemented by a waveform memory device, a counter and a comparator. When the charging control signal 5411 is at low level, i.e. the first audio signal 511 is coupled to the audio output pin 521 of the audio codec chip 52, the monitoring unit 5415 monitors if a waveform on the second audio signal line 5412 is identical to the predetermined waveform in the waveform memory device. When the waveform on the second audio signal line 5412 matches the predetermined waveform, the monitoring unit 5415 directs the switching device 5414 to change state to high using signal 5416, and makes first audio signal 511 connected to the charging module 53.

The monitoring unit 5415 is further coupled to the second audio signal line 512 and switching device 5414 to provide an additional function. When the switching control signal 5412 is at a high level, i.e. the second audio signal 512 is coupled to the audio output pin 521 of the audio codec chip 52, the monitoring unit 5415 monitors if a waveform received by the second audio signal line 512 is identical to the predetermined waveform in the waveform comparator. In the case where the waveform on the second audio signal line 512 matches the predetermined waveform, the monitoring unit 5415 directs the switching device 5414 to change state to high using signal 5417, and makes the second audio signal line 512 connected to the audio output pin 523 of the audio codec chip 52.

This embodiment considers the high level period of the charging control signal 5411 as a charging mode of the portable electronic device 50. When the system 50 is in the charging mode, the audio/charging module 54 electrically couples the first audio signal line 511 of the earphone plug interface 51 to the charging module 53. When the system 50 is not in the charging mode, the audio/charging module 54 electrically couples the first audio signal line 511 to the audio codec chip 52. This embodiment is further capable of switching the portable electronic device 50 to operate in the charging mode when the portable electronic device 50 is not in the charging mode and the first audio signal line 511 receives a predetermined waveform.

In this embodiment, the high level period of the switching control signal 5412 is also considered to be an input mode of the portable electronic device 50. When the system 50 is in the input mode, the audio/charging module 54 electrically couples the second audio signal line 512 of the earphone plug interface 51 to the input pin 522 of the audio codec 52. When the system 50 is not in the input mode, the audio/charging module 54 electrically couples the second audio signal line 512 to the output pin 523 of the audio codec 52. This embodiment is further capable of switching the portable electronic device 50 to leave the input mode when the portable electronic device 50 is in the input mode and the second audio signal line 512 receives a predetermined waveform.

The invention discloses a device charging and inputting an electronic system or a portable electronic device through an earphone plug, thereby reducing circuitry complexity, manufacturing cost, and device dimension.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An audio/charging module in an electronic system with an earphone jack, comprising:
a control unit generating a charging control signal having a first state and second state; and
a switching unit coupled between the earphone jack and a audio codec chip and receiving the charging control signal; wherein the switching unit electrically couples a first audio signal line of the earphone jack to a charging power when the charging control signal is in the first state, and to the codec chip when the charging control signal is in the second state.

2. An audio/charging module as claimed in claim 1, wherein the electronic system charges a portable electronic device coupled to the earphone jack when the charging control signal is in the first state, and the electronic system does not charge the portable electronic device when the charging control signal is in the second state.

3. An audio/charging module as claimed in claim 1, wherein:
the control unit further generates a switching control signal having the first state and second state; and
the switching unit electrically couples to the second audio signal line to an output pin of the audio codec chip when the switching control signal is in the first state, and to an input pin of the audio codec chip when the switching control signal is in the second state.

4. An audio/charging module as claimed in claim 3, wherein the control unit further couples to the second audio signal line; in the case where the switching control signal is in the second state, the control unit sets the switching control signal to the first state when detecting a predetermined waveform on the second audio signal line.

5. An audio/charging module in a portable electronic device capable of connecting with an earphone plug, comprising:
a control unit generating a charging control signal having a first state and a second state, setting the charging control signal as the first state for the electronic system to charge a portable electronic device coupled to the earphone jack, and setting the charging control signal as the second state for the electronic system not to charge the portable electronic device; and
a switching unit coupled between the earphone plug and a audio codec chip and receiving the charging control signal; wherein the switching unit electrically couples a first audio signal line of the earphone plug to a charging module when the charging control signal is in the first state, and to the codec chip when the charging control signal is in the second state.

6. An audio/charging module as claimed in claim 5, wherein the electronic system charges a portable electronic device coupled to the earphone jack when the charging control signal is in the first state, and the electronic system does not charge the portable electronic device when the charging control signal is in the second state.

7. An audio/charging module as claimed in claim 5, wherein the control unit further couples to the first audio signal line; in the case where the charging control signal is in the second state, the control unit sets the charging control signal to the first state when detecting a predetermined signal on the first audio signal line.

8. An audio/charging module as claimed in claim 5, wherein:
the control unit further generates a switching control signal having the first state and second state; and
the switching unit electrically couples to the second audio signal line to an output pin of the audio codec chip when the switching control signal is in the first state, and to an input pin of the audio codec chip when the switching control signal is in the second state.

9. An audio/charging module as claimed in claim 8, wherein the control unit further couples to the second audio signal line; in the case where the switching control signal is in the second state, the control unit sets the switching control signal to the first state when detecting a predetermined signal on the second audio signal line.

10. An electronic system comprising an earphone jack, an audio codec, and an audio/charging module therebetween coupled to a charging power of the electronic system, the electronic system is able to be set to a charging mode, wherein:
the audio/charging module electrically couples a first audio signal line of the earphone jack to the charging power when the electronic system is in the charging mode; and
the audio/charging module electrically couples the first audio signal line to the audio codec chip when the electronic system is not in the charging mode.

11. An electronic system as claimed in claim 10 further being able to set to an input mode, wherein:
the audio/charging module electrically couples to a second audio signal line of the earphone jack to an input pin of the audio codec chip when the electronic system is in the input mode; and
the audio/charging module electrically couples to the second audio signal line of the earphone jack to an output pin of the audio codec chip when the electronic system is not in the input mode.

12. An electronic system as claimed in claim 11, wherein in the case the electronic system is in the input mode, the audio/charging module sets the electronic system to leave the input mode when detect a predetermined signal on the second audio signal line.

13. A portable electronic device comprising an earphone plug interface, an audio codec, and an audio/charging module therebetween coupled to a charging power of the electronic system, and the portable electronic device is capable of being set to a charging mode, wherein:
the audio/charging module electrically couples a first audio signal line of the earphone plug interface to a charging power supply, when the portable electronic device is in the charging mode; and
the audio/charging module electrically couples the first audio signal line to the audio codec chip when the portable electronic device is not in the charging mode.

14. A portable electronic device as claimed in claim 13, wherein in the case the portable electronic device is not in the charging mode, the audio/charging module sets the portable electronic device to the charging mode when detect a predetermined signal on the first audio signal line.

15. A portable electronic device as claimed in claim 13 further capable of being set to an input mode, wherein:
the audio/charging module electrically couples a second audio signal line of the earphone plug interface to an input pin of the audio codec chip when the portable electronic device is in the input mode; and
the audio/charging module electrically couples to the second audio signal line of the earphone jack to an output pin of the audio codec chip when the portable electronic device is not in the input mode.

16. A portable electronic device as claimed in claim 15, wherein in the case where the portable electronic device is in the input mode, the audio/charging module sets the portable electronic device to leave the input mode when detect a predetermined signal on the second audio signal line.
